(19) United States
(12) Patent Application Publication
(10) Pub. No.: US 2025/0240196 A1
(43) Pub. Date: Jul. 24, 2025

(54) OVERLAID OFDM WAVEFORMS FOR LOW POWER SIGNALS

(71) Applicant: Samsung Electronics Co., Ltd., Suwon-si (KR)

(72) Inventor: Hongbo Si, Allen, TX (US)

(21) Appl. No.: 19/011,434

(22) Filed: Jan. 6, 2025

Related U.S. Application Data
(60) Provisional application No. 63/622,408, filed on Jan. 18, 2024.
(60) Provisional application No. 63/624,599, filed on Jan. 24, 2024.

(51) Int. Cl. H04L 27/26; H04W 52/02

(52) U.S. Cl. CPC H04L 27/2614; H04W 52/0206

(57) ABSTRACT

Methods and apparatuses for an overlaid orthogonal frequency-division multiplexing (OFDM) waveforms for low power signals. A method of a user equipment (UE) in a wireless communication system includes identifying a set of OFDM symbols for a low power signal and determining an on-off-key (OOK) waveform for the low power signal. Each OFDM symbol includes one or multiple segments. Each segment corresponds to an ON waveform or an OFF waveform. The method further includes determining a set of overlaid OFDM waveforms and receiving the low power signal based on the OOK waveform and the set of overlaid OFDM waveforms. Each overlaid OFDM waveform is applied to a segment when the segment corresponds to an ON waveform.

### CROSS-REFERENCE TO RELATED AND CLAIM OF PRIORITY

The present application claims priority under 35 U.S.C. § 119(e) to U.S. Provisional Patent Application No. 63/622,408 filed on Jan. 18, 2024; and U.S. Provisional Patent Application No. 63/624,599 filed on Jan. 24, 2024, which are hereby incorporated by reference in their entirety.

### TECHNICAL FIELD

The present disclosure relates generally to wireless communication systems and, more specifically, the present disclosure is related to methods and apparatuses for an overlaid orthogonal frequency-division multiplexing (OFDM) waveforms for low power signals.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to a method and apparatus for an overlaid OFDM waveforms for low power signals.

In one embodiment, a user equipment (UE) is provided. The UE includes a user equipment (UE) in a wireless communication system is provided. The UE includes a processor configured to identify a set of OFDM symbols for a low power signal, determine an on-off-key (OOK) waveform for the low power signal, and determine a set of overlaid OFDM waveforms. Each OFDM symbol includes one or multiple segments. Each segment corresponds to an ON waveform or an OFF waveform. Each overlaid OFDM waveform is applied to a segment when the segment corresponds to an ON waveform. The UE further includes a transceiver operably coupled to the processor. The transceiver is configured to receive the low power signal based on the OOK waveform and the set of overlaid OFDM waveforms.

In another embodiment, a base station (BS) in a wireless communication system is provided. The BS includes a processor configured to identify a set of OFDM symbols for a low power signal, determine an OOK waveform for the low power signal, and determine a set of overlaid OFDM waveforms. Each OFDM symbol includes one or multiple segments. Each segment corresponds to an ON waveform or an OFF waveform. Each overlaid OFDM waveform is applied to a segment when the segment corresponds to an ON waveform. The BS further includes a transceiver operably coupled to the processor. The transceiver is configured to transmit the low power signal based on the OOK waveform and the set of overlaid OFDM waveforms.

In yet another embodiment, a method performed by a user equipment is provided. The method includes identifying a set of OFDM symbols for a low power signal and determining an OOK waveform for the low power signal. Each OFDM symbol includes one or multiple segments. Each segment corresponds to an ON waveform or an OFF waveform. The method further includes determining a set of overlaid OFDM waveforms and receiving the low power signal based on the OOK waveform and the set of overlaid OFDM waveforms. Each overlaid OFDM waveform is applied to a segment when the segment corresponds to an ON waveform.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIGS. 5-7 each illustrate diagrams of an overlaid OFDM-based waveform over an OOK-based waveform according to embodiments of the present disclosure;

FIG. 8 illustrates an example method performed by a UE in a wireless communication system according to embodiments of the present disclosure; and

FIG. 9 illustrates another example method performed by a UE in a wireless communication system according to embodiments of the present disclosure.

### DETAILED DESCRIPTION

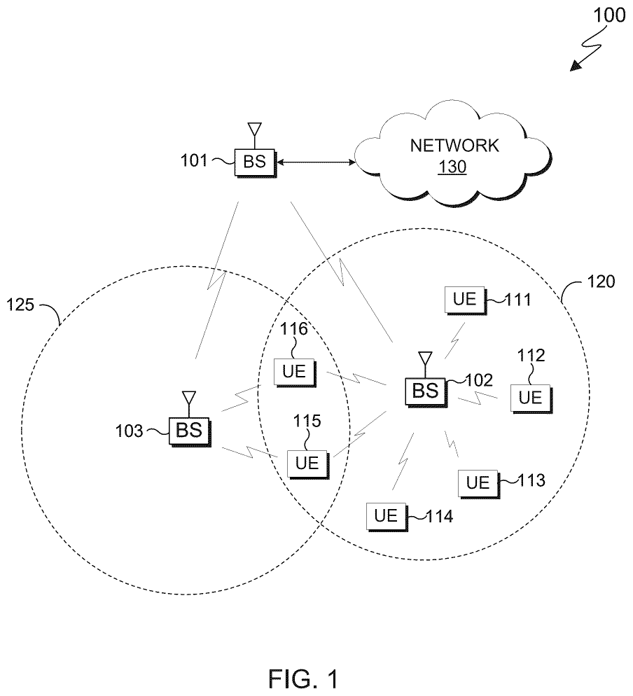

FIGS. 1-9 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP TS 38.211 v17.1.0, “NR; Physical channels and modulation;” [REF2] 3GPP TS 38.212 v17.1.0, “NR; Multiplexing and channel coding;” [REF3] 3GPP TS 38.213 v17.1.0, “NR; Physical layer procedures for control;” [REF4] 3GPP TS 38.214 v17.1.0, “NR; Physical layer procedures for data;” [REF5]3GPP TS 38.331 v17.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying overlaid OFDM waveforms for low power signals. In certain embodiments, one or more of the gNBs 101-103 include circuitry, programing, or a combination thereof to enable the overlaid OFDM waveforms for low power signals.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

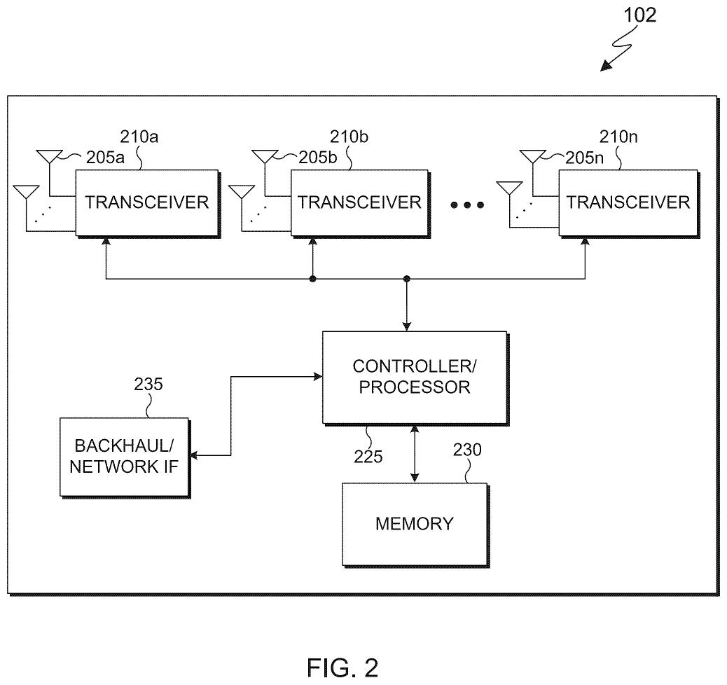

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for enabling overlaid OFDM waveforms for low power signals. Any of a wide variety of other functions could be supported in the gNB 102 by the controller/processor 225.

The controller/processor 225 is also capable of executing programs and other processes resident in the memory 230, such as processes to enable the overlaid OFDM waveforms for low power signals. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

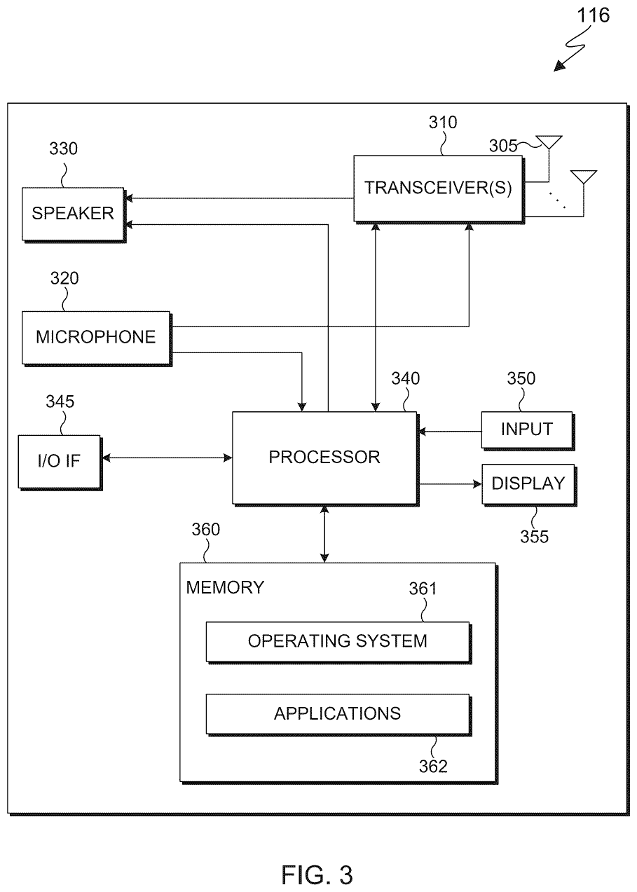

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for identifying overlaid OFDM waveforms for low power signals as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

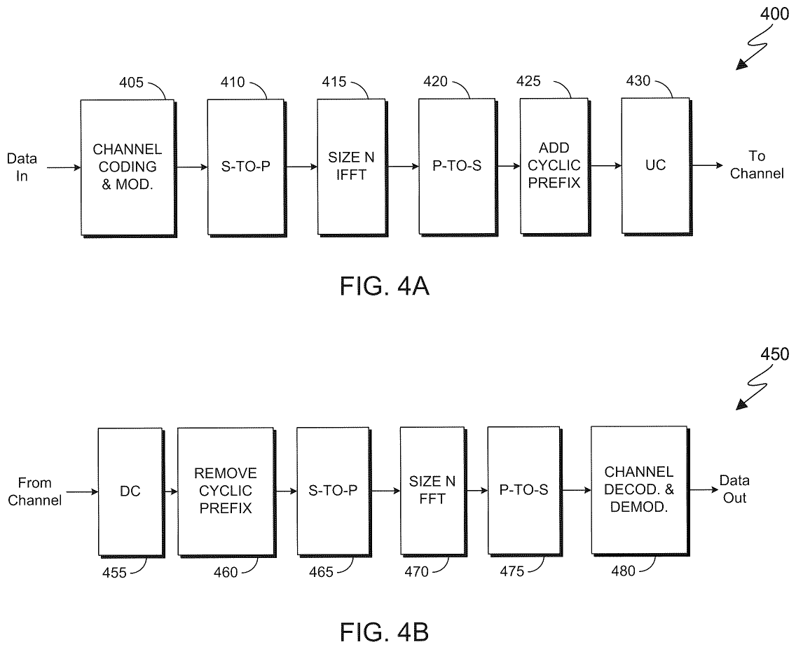

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for enabling overlaid OFDM waveforms for low power signals as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the gNBs 101-103 and may implement a receive path 450 for receiving in the downlink from the gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

NR supported discontinuous reception (DRX) for a UE in either RRC_IDLE/RRC_INACTIVE mode or RRC_CONNECTED mode, such that the UE could stop receiving signals or channels during the inactive period within the DRX cycle and save power consumption. In Rel-16, enhancement towards DRX for RRC_CONNECTED mode (e.g., C-DRX) was introduced, wherein a new DCI format was used to help the UE to skip a ON duration within a C-DRX cycle such that further power saving gain could be achieved. In Rel-17, enhancement towards DRX for RRC_IDLE/RRC_INACTIVE mode (e.g., I-DRX) was introduced, wherein a paging early indication (PEI) was used for a UE to skip monitoring paging occasions such that extra power saving gain could be achieved.

However, the UE still needs to frequently wake up to monitor the new DCI format or the PEI, such that the radio of the UE cannot be fully turned off for a long duration. To avoid such situation and to acquire further power saving gain, an additional receiver radio is considered, wherein the additional receiver radio can be used for monitor a particular set of signals with very low power consumption, and the main receiver radio can be turned off or operating with a very lower power for a long duration.

This disclosure focuses on the overlaid OFDM-based waveform(s) of the low power signals that could be received with low power, e.g., with a waveform enables reception using an additional receiver radio.

Further, this disclosure focuses on the sequence design of the low power signals that could be received with low power, e.g., with a waveform enables reception using an additional receiver radio.

For one example, the low power signals can include a low power wake up signal, e.g., a low power signal for waking up the main receiver.

For another example, the low power signals can include a low power synchronization signal, e.g., a low power signal for synchronization with the low power receiver.

For another example, the low power signals can include a low power wake up signal (LP-WUS), e.g., a low power signal for waking up the main receiver. At least one of the example of this disclosure can be used for the LP-WUS sequence generation.

For another example, the low power signals can include a low power synchronization signal (LP-SS), e.g., a low power signal for synchronization with the low power receiver. At least one of the example of this disclosure can be used for the LP-SS sequence generation.

This disclosure focuses on an overlaid OFDM-based waveform for the low power signal(s). More precisely, the following aspects are included in the present disclosure:
Signal generation with overlaid OFDM-based waveform(s)
   A first type: Overlaid OFDM-based waveform(s) applied to the low power signal which may span one or multiple OFDM symbols
   A second type: Overlaid OFDM-based waveform(s) applied to one OFDM symbol
   A third type: Overlaid OFDM-based waveform(s) applied to a segment in one OFDM symbol
Information carried by the overlaid OFDM-based waveform(s)
Example UE procedure for using the overlaid OFDM-based waveform(s)

Further, this disclosure focuses on sequence design of the overlaid OFDM waveform(s), that is used for generating a low power signal. More precisely, the following aspects are included in the present disclosure:
M-sequence based signal generation
Gold-sequence based signal generation
Pseudo-random-sequence based signal generation
Low-peak-to-average-power ratio (PAPR)-sequence based signal generation
Example UE procedure for sequence generation

Aspects, features, and advantages of the present disclosure are readily apparent from the following detailed description, simply by illustrating a number of particular embodiments and implementations, including the best mode contemplated for carrying out the present disclosure. The present disclosure is also capable of other and different embodiments, and its several details can be modified in various obvious respects, all without departing from the spirit and scope of the present disclosure. Accordingly, the drawings and description are to be regarded as illustrative in nature, and not as restrictive. The present disclosure is illustrated by way of example, and not by way of limitation, in the figures of the accompanying drawings.

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

When low power signal(s) includes multiple types of signals, each type of the signal can be according to examples in this disclosure jointly or separately.

One component provided by the present disclosure relates signal generation with an overlaid OFDM waveform.

In one embodiment, a low power signal can be generated based on a OOK-based waveform and further based on an overlaid OFDM-based waveform.

For one example, a low power signal from time instance T to T+d can be generated according to s(t)=s_{OOK}(t)·s_{OFDM}(t), wherein s_{OOK}(t) is generated based on an OOK-based waveform, and s_{OFDM}(t) is generated based on OFDM-based waveform.

For another example, a low power signal from time instance T to T+d can be generated according to

$$s ( t ) = \{ \begin{matrix}{s}_{OOK} ( t ) \cdot {s}_{OFDM} ( t ) , if {s}_{OOK} ( t ) \neq 0 \\ 0 , otherwise\end{matrix} ,$$

wherein s_{OOK}(t) is generated based on the OOK-based waveform (e.g., a value of s_{OOK}(t) can correspond to either an ON value (such as 1 or non-zero value based on transmission power) or an OFF value (such as 0)), and s_{OFDM}(t) is generated based on the OFDM-based waveform.

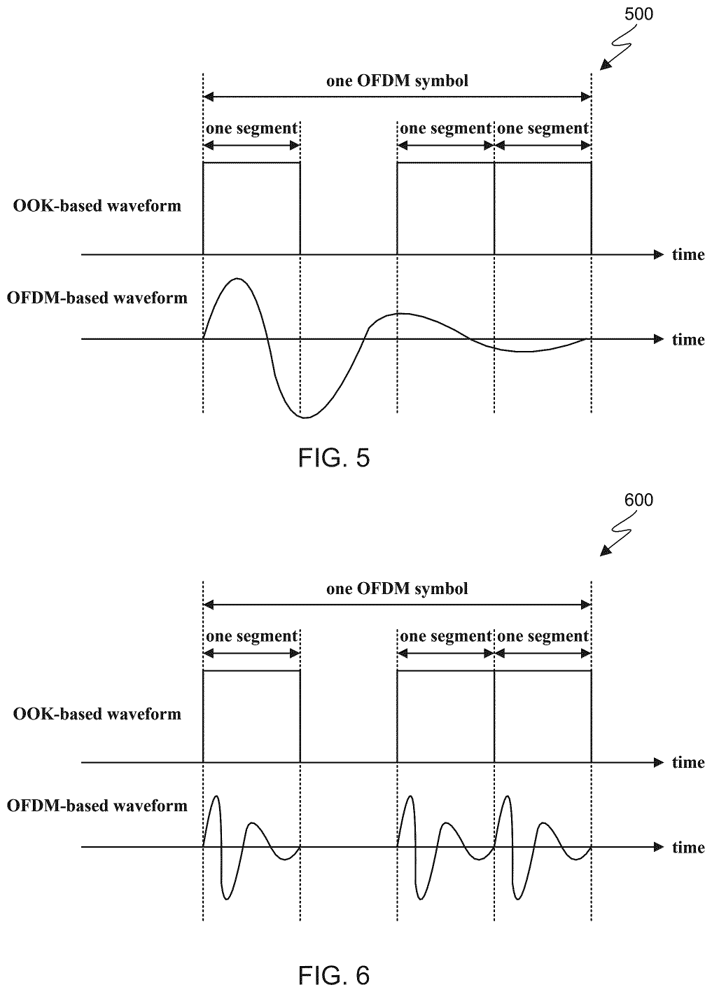

FIGS. 5-7 illustrate diagrams 500, 600, and 700, respectively, of overlaid OFDM-based waveforms over OOK-based waveforms according to embodiments of the present disclosure. For example, the waveforms of diagram 500, 600, or 700 can be implemented by gNB 102 of FIG. 1. These examples are for illustration only and other embodiments can be used without departing from the scope of the present disclosure.

For one consideration of examples of this embodiment, as illustrated in FIG. 5, the time instance T to T+d can corresponds to a ODFM symbol (e.g., without CP), and the overlaid OFDM sequence is applied to the whole OFDM symbol (e.g., when the OFDM symbol includes multiple segments, the overlaid OFDM sequence is applied to the multiple segments).

For another consideration of examples of this embodiment, as illustrated in FIG. 6, the time instance T to T+d can corresponds to a segment in a ODFM symbol (e.g., without CP), wherein a OFDM symbol can include one or multiple segments (e.g., a segment can correspond to either an ON value or an OFF value), and the overlaid OFDM sequence is applied to each segment (e.g., when the OFDM symbol includes multiple segments, the overlaid OFDM sequence is applied to each of the multiple segments).

For yet another consideration of examples of this embodiment, as illustrated in FIG. 6, the time instance T to T+d can corresponds to one or multiple ODFM symbols (e.g., the OFDM symbols that the low power signal spans), and the overlaid OFDM sequence is applied to the one or multiple OFDM symbols.

For yet another consideration of examples of this embodiment, whether to apply the overlaid ODFM-based waveform (e.g., s_{OFDM}(t)) in the generation of s(t) can be determined based on a higher layer parameter. For instance, if a higher layer parameter is provided, the overlaid ODFM-based waveform (e.g., s_{OFDM}(t)) is applied and generated based on ODFM-based waveform according to example of this disclosure; and if the higher layer parameter is not provided, the overlaid ODFM-based waveform (e.g., s_{OFDM}(t)) is not applied (e.g., or equivalently applying s_{OFDM}(t)=1 or a constant value based on transmission power).

For yet another consideration of examples of this embodiment, whether to apply the overlaid ODFM-based waveform (e.g., s_{OFDM}(t)) in the generation of s(t) can be subject to a UE capability. For instance, a UE can report whether it has a capability to decode information included in the overlaid OFDM-based waveform (e.g., s_{OFDM}(t)). For another instance, whether the UE prefers to use the overlaid ODFM-based waveform (e.g., s_{OFDM}(t)) can be provided in UE assistant information.

For yet another consideration of examples of this embodiment, whether to apply the OOK-based waveform (e.g., s_{OOK}(t)) in the generation of s(t) can be determined based on a higher layer parameter. For instance, if a higher layer parameter is provided, the OOK-based waveform (e.g., s_{OOK}(t)) is applied and generated based on OOK-based waveform; and if the higher layer parameter is not provided, s_{OOK}(t) is not applied (e.g., or equivalently applying s_{OOK}(t)=1 or a constant value based on transmission power).

For yet another consideration of examples of this embodiment, whether to apply the OOK-based waveform (e.g., s_{OOK}(t)) in the generation of s(t) can be subject to a UE capability. For instance, a UE can report whether it has a capability to decode information included in the OOK-based waveform (e.g., s_{OOK}(t)). For another instance, whether the UE prefers to use the OOK-based waveform (e.g., s_{OOK}(t)) can be provided in UE assistant information.

For yet another consideration of examples of this embodiment, the low power signals can include a low power wake up signal (LP-WUS), e.g., a low power signal for waking up the main receiver. For one further instance, the LP-WUS can be associated with a low power synchronization signal in each of its transmission, wherein the low power synchronization signal is not periodic.

For yet another consideration of examples of this embodiment, the low power signals can include a low power synchronization signal (LP-SS), e.g., a low power signal for synchronization with the low power receiver, and/or e.g., the LP-SS is periodic transmitted.

Another component provided by the present disclosure relates to information carried by the overlaid OFDM-based waveform.

In one embodiment, the overlaid OFDM-based waveform can carry information.

For one further consideration, the information carried by the overlaid OFDM-based waveform can be either explicitly carried by the sequence that generating the overlaid OFDM-based waveform (e.g., by the initial condition, cyclic shift, phase shift, etc.), and/or implicitly carried by the location of the sequence in the time and/or frequency domain, and/or the combination of the two methods (e.g., explicit method and implicit method).

For one example, the overlaid OFDM-based waveform (e.g., s_{OFDM}(t) as in the examples of this disclosure) can be applied to the OFDM symbols that span the low power signal (e.g., as shown in FIG. 7), and the information carried by the OFDM-based waveform (e.g., denoted by I_{OFDM}) can be the same as the information carried by the OOK-based waveform (e.g., denoted by I_{OOK}), e.g., I_{OFDM}=I_{OOK}.

For another example, the overlaid OFDM-based waveform (e.g., s_{OFDM}(t) as in the examples of this disclosure) can be applied to the OFDM symbols that span the low power signal (e.g., as shown in FIG. 7), and the information carried by the OFDM-based waveform (e.g., denoted by I_{OFDM}) can be a subset of the information carried by the OOK-based waveform (e.g., denoted by I_{OOK}), I_{OFDM}=I_{OOK}.

For another example, the overlaid OFDM-based waveform (e.g., s_{OFDM}(t) as in the examples of this disclosure) can be applied to one OFDM symbol that is included in the OFDM symbols spanned by the low power signal (e.g., as shown in FIG. 5), and the information carried by the OFDM-based waveform (e.g., denoted by I_{OFDM}) can be the same as the information carried by the OOK-based waveform (e.g., denoted by I_{OOK}), e.g., I_{OFDM}=I_{OOK}, other than the OFDM symbol index (e.g., the OFDM symbol index is not counted in either I_{OFDM} or I_{OOK}).
For one sub-example, when the OFDM symbols spanned by the low power signal are multiple, the overlaid OFDM-based waveform can be the different across the multiple OFDM symbols. For instance, the sequence generated in different OFDM symbols spanned by the low power signal can depend on the OFDM symbol index.

For yet another example, the overlaid OFDM-based waveform (e.g., s_{OFDM}(t) as in the examples of this disclosure) can be applied to one OFDM symbol that is included in the OFDM symbols spanned by the low power signal (e.g., as shown in FIG. 5), and the information carried by the OFDM-based waveform (e.g., denoted by I_{OFDM}) can be a subset of the information carried by the OOK-based waveform (e.g., denoted by I_{OOK}), e.g., I_{OFDM} ⊆I_{OOK}.
For one sub-example, when the OFDM symbols spanned by the low power signal are multiple, the overlaid OFDM-based waveform can be the same across the multiple OFDM symbols.
For another sub-example, when the OFDM symbols spanned by the low power signal are multiple, the overlaid OFDM-based waveform can be the different across the multiple OFDM symbols. For instance, the sequence generated in different OFDM symbols spanned by the low power signal can depend on the OFDM symbol index.

For yet another example, the overlaid OFDM-based waveform (e.g., s_{OFDM}(t) as in the examples of this disclosure) can be applied to one OFDM symbol that is included in the OFDM symbols spanned by the low power signal (e.g., as shown in FIG. 5), and the information carried by the OFDM-based waveform (e.g., denoted by I_{OFDM}) can be a subset of the information carried by the OOK-based waveform (e.g., denoted by I_{OOK}), e.g., I_{OFDM} ⊆I_{OOK}, other than the OFDM symbol index (e.g., the OFDM symbol index is not counted in either I_{OFDM} or I_{OOK}).
For one sub-example, when the OFDM symbols spanned by the low power signal are multiple, the overlaid OFDM-based waveform can be the different across the multiple OFDM symbols. For instance, the sequence generated in different OFDM symbols spanned by the low power signal can depend on the OFDM symbol index.

For one example, the overlaid OFDM-based waveform (e.g., s_{OFDM}(t) as in the examples of this disclosure) can be applied to one segment (e.g., corresponding to either an ON or an OFF value in OOK waveform) within a OFDM symbol that is included in the OFDM symbols spanned by the low power signal (e.g., as shown in FIG. 6), and the information carried by the OFDM-based waveform (e.g., denoted by I_{OFDM}) can be the same as the information carried by the OOK-based waveform (e.g., denoted by I_{OOK}), e.g., I_{OFDM}=I_{OOK}
For one sub-example, when the segments in one OFDM symbol are multiple, the overlaid OFDM-based waveform can be the same across the multiple segments.
For another sub-example, when the segments in one OFDM symbol are multiple, the overlaid OFDM-based waveform can be the different across the multiple segments. For instance, the sequence generated in different segments can depend on the segment index and/or OFDM symbol index.

For another example, the overlaid OFDM-based waveform (e.g., s_{OFDM}(t) as in the examples of this disclosure) can be applied to one segment (e.g., corresponding to either an ON or an OFF value in OOK waveform) within a OFDM symbol that is included in the OFDM symbols spanned by the low power signal (e.g., as shown in FIG. 6), and the information carried by the OFDM-based waveform (e.g., denoted by I_{OFDM}) can be the same as the information carried by the OOK-based waveform (e.g., denoted by I_{OOK}), e.g., I_{OFDM}=I_{OOK}, other than the OFDM symbol index and/or segment index (e.g., the OFDM symbol index and/or segment index is not counted in either I_{OFDM} or I_{OOK}).
For one sub-example, when the segments in one OFDM symbol are multiple, the overlaid OFDM-based waveform can be the different across the multiple segments. For instance, the sequence generated in different segments can depend on the segment index and/or OFDM symbol index.

For yet another example, the overlaid OFDM-based waveform (e.g., s_{OFDM}(t) as in the examples of this disclosure) can be applied to one segment (e.g., corresponding to either an ON or an OFF value in OOK waveform) within a OFDM symbol that is included in the OFDM symbols spanned by the low power signal (e.g., as shown in FIG. 6), and the information carried by the OFDM-based waveform (e.g., denoted by I_{OFDM}) can be a subset of the information carried by the OOK-based waveform (e.g., denoted by I_{OOK}), e.g., I_{OFDM} ⊆I_{OOK}.
For one sub-example, when the segments in one OFDM symbol are multiple, the overlaid OFDM-based waveform can be the same across the multiple segments.
For another sub-example, when the segments in one OFDM symbol are multiple, the overlaid OFDM-based waveform can be the different across the multiple segments. For instance, the sequence generated in different segments can depend on the segment index and/or OFDM symbol index.
For yet another sub-example, the combination of information carried by the segments in all the OFDM symbols spanned by the low power signal can be same as the information carried by the OOK-based waveform. For instance, this combination of information carried by the segments does not include the segment index and/or OFDM symbol index. The UE can acquire same information by detection from the OOK-based waveform of the low power signal and detection from the OFDM-based waveform in the segments of the low power signal.

For yet another example, the overlaid OFDM-based waveform (e.g., s_{OFDM}(t) as in the examples of this disclosure) can be applied to one segment (e.g., corresponding to either an ON or an OFF value in OOK waveform) within a OFDM symbol that is included in the OFDM symbols spanned by the low power signal (e.g., as shown in FIG. 6), and the information carried by the OFDM-based waveform (e.g., denoted by I_{OFDM}) can be a subset of the information carried by the OOK-based waveform (e.g., denoted by I_{OOK}), e.g., I_{OFDM} ⊆I_{OOK}, other than the OFDM symbol index and/or segment index (e.g., the OFDM symbol index and/or segment index is not counted in either I_{OFDM} or I_{OOK}).
For one sub-example, when the segments in one OFDM symbol are multiple, the overlaid OFDM-based waveform can be the different across the multiple segments. For instance, the sequence generated in different segments can depend on the segment index and/or OFDM symbol index.
For yet another sub-example, the combination of information carried by the segments in all the OFDM symbols spanned by the low power signal can be same as the information carried by the OOK-based waveform. For instance, this combination of information carried by the segments does not include the segment index and/or OFDM symbol index. The UE can acquire same information by detection from the OOK-based waveform of the low power signal and detection from the OFDM-based waveform in the segments of the low power signal.

Another component provided by the present disclosure relates to an example UE procedure.

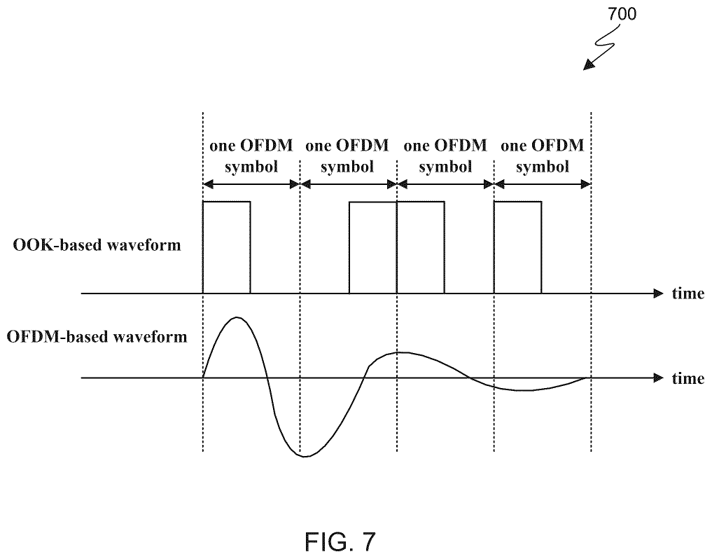

FIG. 8 illustrates an example method 800 performed by a UE in a wireless communication system according to embodiments of the present disclosure. The method 800 of FIG. 8 can be performed by any of the UEs 111-116 of FIG. 1, such as the UE 116 of FIG. 3, and a corresponding method can be performed by any of the gNBs 101-103 of FIG. 1, such as gNB 102 of FIG. 2. The method 800 is for illustration only and other embodiments can be used without departing from the scope of the present disclosure.

In one embodiment, as illustrated in FIG. 8, the example method 800 is for receiving the overlaid OFDM-based waveform. The method 800 begins with the UE receiving a low power signal (810). The UE then determines the overlaid OFDM-based waveform included in the low power signal (820). The UE then determines the information carried by the overlaid OFDM-based waveform (830).

Another component provided by the present disclosure relates to M-sequence based signal generation.

In one embodiment, an overlaid OFDM-based waveform for a low power signal can be generated based on a M-sequence.

In one example, the sequence generation is in the frequency domain. For instance, a BPSK modulated M-sequence is mapped to a consecutive number (e.g., L) of subcarriers in the frequency domain and then performed with IFFT operation to generate the overlaid OFDM-based waveform in the time domain.

In another example, the sequence generation is in the time domain. For instance, a BPSK modulated M-sequence is mapped to a consecutive number (e.g., L) of samples in the time domain.

In one example, the BPSK modulated M-sequence can be given by:

$${d}_{OFDM} ( n ) = 1 - 2 \cdot x ( m ) ,$$

$$m = ( n + {n}_{cs} ) mod L ,$$

$$0 \leq n < L .$$

In one example, L=127, and the corresponding generation method for the M-sequence x(i) can be determined as one from Table 1.

TABLE 1
Example M-sequence generation method with length 127

| | | Corresponding |
|---|---|---|
| | Generator | generation method |
| Index | polynomial g(x) | (i = 0, 1, . . . , 119) |
| 1 | x\hat{ }7 + x\hat{ }6 + 1 | x(i + 7) = x(i + 6) + x(i) |
| 2 | x\hat{ }7 + x + 1 | x(i + 7) = x(i + 1) + x(i) |
| 3 | x\hat{ }7 + x\hat{ }4 + 1 | x(i + 7) = x(i + 4) + x(i) |
| 4 | x\hat{ }7 + x\hat{ }3 + 1 | x(i + 7) = x(i + 3) + x(i) |
| 5 | x\hat{ }7 + x\hat{ }6 + x\hat{ }5 + | x(i + 7) = x(i + 6) + x(i + 5) + |
| | x\hat{ }4 + 1 | x(i + 4) + x(i) |
| 6 | x\hat{ }7 + x\hat{ }3 + x\hat{ }2 + | x(i + 7) = x(i + 3) + x(i + 2) + |
| | x + 1 | x(i + 1) + x(i) |
| 7 | x\hat{ }7 + x\hat{ }6 + x\hat{ }5 + | x(i + 7) = x(i + 6) + x(i + 5) + |
| | x\hat{ }2 + 1 | x(i + 2) + x(i) |
| 8 | x\hat{ }7 + x\hat{ }5 + x\hat{ }2 + | x(i + 7) = x(i + 5) + x(i + 2) + |
| | x + 1 | x(i + 1) + x(i) |
| 9 | x\hat{ }7 + x\hat{ }5 + x\hat{ }4 + | x(i + 7) = x(i + 5) + x(i + 4) + |
| | x\hat{ }3 + 1 | x(i + 3) + x(i) |
| 10 | x\hat{ }7 + x\hat{ }4 + x\hat{ }3 + | x(i + 7) = x(i + 4) + x(i + 3) + |
| | x\hat{ }2 + 1 | x(i + 2) + x(i) |
| 11 | x\hat{ }7 + x\hat{ }6 + x\hat{ }4 + | x(i + 7) = x(i + 6) + x(i + 4) + |
| | x\hat{ }2 + 1 | x(i + 2) + x(i) |
| 12 | x\hat{ }7 + x\hat{ }5 + x\hat{ }3 + | x(i + 7) = x(i + 5) + x(i + 3) + |
| | x + 1 | x(i + 1) + x(i) |
| 13 | x\hat{ }7 + x\hat{ }6 + x\hat{ }4 + | x(i + 7) = x(i + 6) + x(i + 4) + |
| | x + 1 | x(i + 1) + x(i) |
| 14 | x\hat{ }7 + x\hat{ }6 + x\hat{ }3 + | x(i + 7) = x(i + 6) + x(i + 3) + |
| | x + 1 | x(i + 1) + x(i) |
| 15 | x\hat{ }7 + x\hat{ }5 + x\hat{ }4 + | x(i + 7) = x(i + 5) + x(i + 4) + |
| | x\hat{ }3 + x\hat{ }2 + x + 1 | x(i + 3) + x(i + 2) + x(i + 1) + x(i) |
| 16 | x\hat{ }7 + x\hat{ }6 + x\hat{ }5 + | x(i + 7) = x(i + 6) + x(i + 5) + |
| | x\hat{ }4 + x\hat{ }3 + x\hat{ }2 + 1 | x(i + 4) + x(i + 3) + x(i + 2) + x(i) |
| 17 | x\hat{ }7 + x\hat{ }6 + x\hat{ }5 + | x(i + 7) = x(i + 6) + x(i + 5) + |
| | x\hat{ }3 + x\hat{ }2 + x + 1 | x(i + 3) + x(i + 2) + x(i + 1) + x(i) |
| 18 | x\hat{ }7 + x\hat{ }6 + x\hat{ }5 + | x(i + 7) = x(i + 6) + x(i + 5) + |
| | x\hat{ }4 + x\hat{ }2 + x + 1 | x(i + 4) + x(i + 2) + x(i + 1) + x(i) |

In another example, L=255, and the corresponding generation method for the M-sequence x(i) can be determined as one from Table 2.

TABLE 2
Example M-sequence generation method with length 255

| | | Corresponding |
|---|---|---|
| | Generator | generation method |
| Index | polynomial g(x) | (i = 0, 1, . . . , 246) |
| 1 | x\hat{ }8 + x\hat{ }7 + x\hat{ }6 + x + 1 | x(i + 8) = x(i + 7) + x(i + 6) + |
| | | x(i + 1) + x(i) |
| 2 | x\hat{ }8 + x\hat{ }7 + x\hat{ }2 + x + 1 | x(i + 8) = x(i + 7) + x(i + 2) + |
| | | x(i + 1) + x(i) |
| 3 | x\hat{ }8 + x\hat{ }7 + x\hat{ }5 + x\hat{ }3 + 1 | x(i + 8) = x(i + 7) + x(i + 5) + |
| | | x(i + 3) + x(i) |
| 4 | x\hat{ }8 + x\hat{ }5 + x\hat{ }3 + x + 1 | x(i + 8) = x(i + 5) + x(i + 3) + |
| | | x(i + 1) + x(i) |
| 5 | x\hat{ }8 + x\hat{ }6 + x\hat{ }5 + x\hat{ }4 + 1 | x(i + 8) = x(i + 6) + x(i + 5) + |
| | | x(i + 4) + x(i) |
| 6 | x\hat{ }8 + x\hat{ }4 + x\hat{ }3 + x\hat{ }2 + 1 | x(i + 8) = x(i + 4) + x(i + 3) + |
| | | x(i + 2) + x(i) |
| 7 | x\hat{ }8 + x\hat{ }6 + x\hat{ }5 + x\hat{ }3 + 1 | x(i + 8) = x(i + 6) + x(i + 5) + |
| | | x(i + 3) + x(i) |
| 8 | x\hat{ }8 + x\hat{ }5 + x\hat{ }3 + x\hat{ }2 + 1 | x(i + 8) = x(i + 5) + x(i + 3) + |
| | | x(i + 2) + x(i) |
| 9 | x\hat{ }8 + x\hat{ }6 + x\hat{ }5 + x\hat{ }2 + 1 | x(i + 8) = x(i + 6) + x(i + 5) + |
| | | x(i + 2) + x(i) |
| 10 | x\hat{ }8 + x\hat{ }6 + x\hat{ }3 + x\hat{ }2 + 1 | x(i + 8) = x(i + 6) + x(i + 3) + |
| | | x(i + 2) + x(i) |
| 11 | x\hat{ }8 + x\hat{ }6 + x\hat{ }5 + x + 1 | x(i + 8) = x(i + 6) + x(i + 5) + |
| | | x(i + 1) + x(i) |
| 12 | x\hat{ }8 + x\hat{ }7 + x\hat{ }3 + x\hat{ }2 + 1 | x(i + 8) = x(i + 7) + x(i + 3) + |
| | | x(i + 2) + x(i) |
| 13 | x\hat{ }8 + x\hat{ }7 + x\hat{ }6 + x\hat{ }5 + | x(i + 8) = x(i + 7) + x(i + 6) + |
| | x\hat{ }4 + x\hat{ }2 + 1 | x(i + 5) + x(i + 4) + x(i + 2) + x(i) |
| 14 | x\hat{ }8 + x\hat{ }6 + x\hat{ }4 + x\hat{ }3 + | x(i + 8) = x(i + 6) + x(i + 4) + |
| | x\hat{ }2 + x + 1 | x(i + 3) + x(i + 2) + x(i + 1) + x(i) |
| 15 | x\hat{ }8 + x\hat{ }7 + x\hat{ }6 + x\hat{ }5 + | x(i + 8) = x(i + 7) + x(i + 6) + |
| | x\hat{ }2 + x + 1 | x(i + 5) + x(i + 2) + x(i + 1) + x(i) |
| 16 | x\hat{ }8 + x\hat{ }7 + x\hat{ }6 + x\hat{ }3 + | x(i + 8) = x(i + 7) + x(i + 6) + |
| | x\hat{ }2 + x + 1 | x(i + 3) + x(i + 2) + x(i + 1) + x(i) |

In one example, the cyclic shift applied to the M-sequence (e.g., n_{cs}) can be fixed as 0.

In another example, the cyclic shift can be determined based on the information carried by the overlaid OFDM-based waveform.

In one example, the initial condition can be determined based on the information carried by the overlaid OFDM-based waveform.

In another example, the initial condition can be fixed. For one instance, for L=127, the initial condition for generating the M-sequence x(i) can be according to x(6:0)=[0 0 0 0 0 0 1]. For another instance, for L=255, the initial condition for generating the M-sequence x(i) can be according to x(7:0)=[0 0 0 0 0 0 0 1].

Another component provided by the present disclosure relates to Gold-sequence based signal generation.

In one embodiment, an overlaid OFDM-based waveform for alow power signal can be generated based on a Gold-sequence.

In one example, the sequence generation can be in the frequency domain. For instance, a BPSK modulated Gold-sequence is mapped to a consecutive number (e.g., L) of subcarriers in the frequency domain and then performed with IFFT operation to generate the overlaid OFDM-based waveform.

In another example, the sequence generation can be in the time domain. For instance, a BPSK modulated Gold-sequence is mapped to a consecutive number (e.g., L) of samples in the time domain to generate the overlaid OFDM-based waveform.

In one example, the BPSK modulated Gold-sequence can be given by:

$${d}_{OFDM} ( n ) = ( 1 - 2 \cdot {x}_{0} ( {n}_{0} ) ) \cdot ( 1 - 2 \cdot {x}_{1} ( {n}_{1} ) ) ,$$

$${n}_{0} = ( n + {m}_{0} ) mod L ,$$

$${n}_{1} = ( n + {m}_{1} ) mod L ,$$

$$0 \leq n < L .$$

In one example, L=127, and the corresponding generation method for the M-sequence x₀(i) can be determined as a first one from Table 1, and the corresponding generation method for the M-sequence x₁(i) can be determined as a second one from Table 1, wherein the first one and the second one are different.

In another example, L=255, and the corresponding generation method for the M-sequence x₀(i) can be determined as a first one from Table 2, and the corresponding generation method for the M-sequence x₁(i) can be determined as a second one from Table 2, wherein the first one and the second one are different.

In one example, the cyclic shift applied to the M-sequence x₀(i) (e.g. m₀) can be fixed as 0.

In another example, the cyclic shift applied to the M-sequence x₀(i) (e.g. m₀) can be determined based on the information or part of the information carried by the overlaid OFDM-based waveform.

In one example, the cyclic shift applied to the M-sequence x₁(i) (e.g. mi) can be fixed as 0.

In another example, the cyclic shift applied to the M-sequence x₁(i) (e.g. mi) can be determined based on the information or part of the information carried by the overlaid OFDM-based waveform.

In one example, the initial condition for the M-sequence x₀(i) can be determined based on the information or part of the information carried by the overlaid OFDM-based waveform.

In another example, the initial condition for the M-sequence x₀(i) can be fixed. For one instance, for L=127, the initial condition for generating the M-sequence x₀(i) can be according to x₀(6:0)=[0 0 0 0 0 0 1]. For another instance, for L=255, the initial condition for generating the M-sequence x₀(i) can be according to x₀(7:0)=[0 0 0 0 0 0 0 1].

In one example, the initial condition for the M-sequence x₁(i) can be determined based on the information or part of the information carried by the overlaid OFDM-based waveform.

In another example, the initial condition for the M-sequence x₁(i) can be fixed. For one instance, for L=127, the initial condition for generating the M-sequence x₁(i) can be according to x₁(6:0)=[0 0 0 0 0 0 1]. For another instance, for L=255, the initial condition for generating the M-sequence x₁(i) can be according to x₁(7:0)=[0 0 0 0 0 0 0 1].

Another component provided by the present disclosure relates to pseudo-random-sequence based signal generation.

In one embodiment, an overlaid OFDM-based waveform for a low power signal can be generated based on a pseudo-random-sequence (or PN-sequence).

In one example, the sequence generation can be in the frequency domain. For instance, a QPSK modulated pseudo-random-sequence is mapped to a number (e.g., L) of subcarriers in the frequency domain and then performed with IFFT operation to generate the overlaid OFDM-based waveform.

In another example, the sequence generation can be in the time domain. For instance, a QPSK modulated pseudo-random-sequence is mapped to a number (e.g., L) of samples in the time domain to generate the overlaid OFDM-based waveform.

In one example, the QPSK modulated pseudo-random-sequence can be given by:

$${d}_{OFDM} ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) , wherein$$

$$c ( n ) = ( {x}_{1} ( n + {N}_{c} ) + {x}_{2} ( x + {N}_{C} ) ) mod 2 ,$$

$${x}_{1} ( n + 31 ) = ( {x}_{1} ( n + 3 ) + {x}_{1} ( n ) ) mod 2 ,$$

$${x}_{1} ( n + 31 ) = ( {x}_{1} ( n + 3 ) + {x}_{1} ( n + 2 ) + {x}_{1} ( n + 1 ) + {x}_{1} ( n ) ) mod 2 ,$$

$${N}_{c} = 16 \; 00 ,$$

$${x}_{1} ( 30 : 0 ) = [ 0 , … , 0 , 1 ] ,$$

$${c}_{init} = {\sum }_{i = 0}^{30} {x}_{2} ( i ) \cdot {2}^{i} .$$

In one example, the initial condition cᵢₙᵢₜ can be determined based on the information or part of the information carried by the overlaid OFDM-based waveform.

Another component provided by the present disclosure relates to low-PAPR-sequence (e.g., also known as Zadoff-Chu sequence or ZC-sequence) based signal generation.

In one embodiment, an overlaid OFDM-based waveform for a low power signal can be generated based on a low-PAPR-sequence (or ZC-sequence).

In one example, the sequence generation can be in the frequency domain. For instance, a low-PAPR-sequence is mapped to a number (e.g., L) of subcarriers in the frequency domain and then performed with IFFT operation to generate the overlaid OFDM-based waveform.

In another example, the sequence generation can be in the time domain. For instance, a low-PAPR-sequence is mapped to a number (e.g., L) of samples in the time domain to generate the overlaid OFDM-based waveform.

In one example, the low-PAPR-sequence can be given by:

$${d}_{OFDM} ( n ) = \frac{1}{\sqrt{L}} {\sum }_{i = 0}^{L - 1} r ( i ) {e}^{- j \frac{2 π in}{L}} ,$$

$$or$$

$${d}_{OFDM} ( n ) = {x}_{q} ( n mod L )$$

$$where$$

$${x}_{q} ( m ) = {e}^{- j \frac{π m ( m + 1 )}{L}} .$$

In one example, the r(i) or q can be determined based on the information or part of the information carried by the overlaid OFDM-based waveform, and/or L is the length of the ZC-sequence, e.g., which can be given by the largest prime number such that L<12·N_{RB}/M, where N_{RB} is the number of RBs used for the low power signal in the frequency domain, and M is the number of segments in one OFDM symbol for OOK waveform.

Another component provided by the present disclosure relates to another example UE procedure.

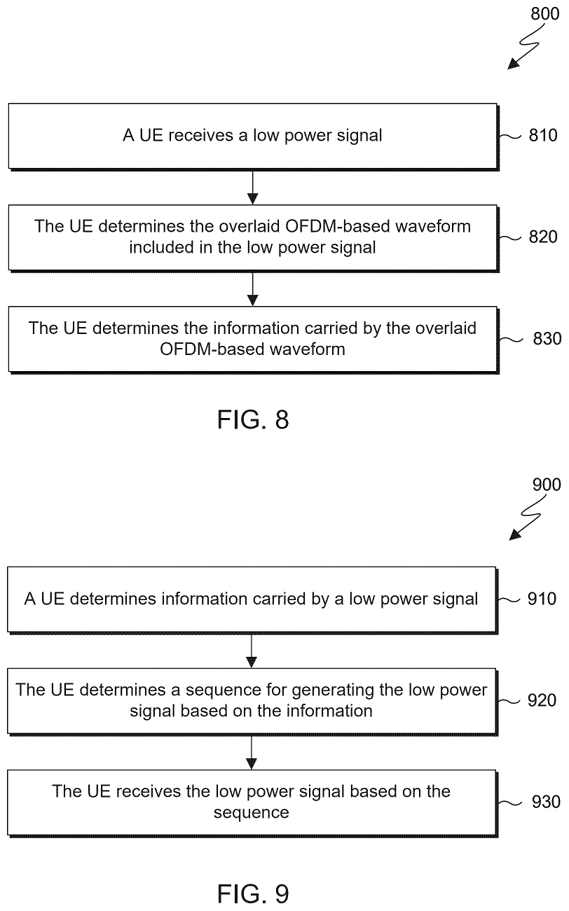

FIG. 9 illustrates an example method 900 performed by a UE in a wireless communication system according to embodiments of the present disclosure. The method 900 of FIG. 9 can be performed by any of the UEs 111-116 of FIG. 1, such as the UE 116 of FIG. 3, and a corresponding method can be performed by any of the gNBs 101-103 of FIG. 1, such as gNB 102 of FIG. 2. The method 900 is for illustration only and other embodiments can be used without departing from the scope of the present disclosure.

In one embodiment, as illustrated in FIG. 9, the example method 900 is for receiving the low power signal based on the sequence. The method 900 begins with the UE determining information carried by a low power signal (910). The UE then determines a sequence for generating the low power signal based on the information (920). The UE then receives the low power signal based on the sequence (930).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
identify a set of orthogonal frequency division multiplexing (OFDM) symbols for a low power signal, wherein each OFDM symbol includes one or multiple segments;
determine an on-off-key (OOK) waveform for the low power signal, wherein each segment corresponds to an ON waveform or an OFF waveform; and
determine a set of overlaid OFDM waveforms, wherein each overlaid OFDM waveform is applied to a segment when the segment corresponds to an ON waveform; and
a transceiver operably coupled to the processor, the transceiver configured to receive the low power signal based on the OOK waveform and the set of overlaid OFDM waveforms.

2. The UE of claim 1, wherein the low power signal is one of a low power synchronization signal (LP-SS) or a low power wake up signal (LP-WUS).

3. The UE of claim 1, wherein information carried by an overlaid OFDM waveform in the set of overlaid OFDM waveforms is a subset of information carried by the OOK waveform.

4. The UE of claim 1, wherein information carried by a first overlaid OFDM waveform in the set of overlaid OFDM waveforms is different from information carried by a second overlaid OFDM waveform in the set of overlaid OFDM waveforms when the first overlaid OFDM waveform and the second overlaid OFDM waveform correspond to different segments in the OFDM symbol.

5. The UE of claim 1, wherein information carried by the set of overlaid OFDM waveforms is same as information carried by the OOK waveform.

6. The UE of claim 1, wherein an overlaid OFDM waveform in the set of overlaid OFDM waveforms is generated in a frequency domain and mapped to a number of subcarriers in the frequency domain.

7. The UE of claim 1, wherein an overlaid OFDM waveform in the set of overlaid OFDM waveforms is generated according to a low peak-to-average-power ratio (PAPR) sequence.

8. A base station (BS) in a wireless communication system, the BS comprising:
a processor configured to:
identify a set of orthogonal frequency division multiplexing (OFDM) symbols for a low power signal, wherein each OFDM symbol includes one or multiple segments;
determine an on-off-key (OOK) waveform for the low power signal, wherein each segment corresponds to an ON waveform or an OFF waveform; and
determine a set of overlaid OFDM waveforms, wherein each overlaid OFDM waveform is applied to a segment when the segment corresponds to an ON waveform; and
a transceiver operably coupled to the processor, the transceiver configured to transmit the low power signal based on the OOK waveform and the set of overlaid OFDM waveforms.

9. The BS of claim 8, wherein the low power signal is one of a low power synchronization signal (LP-SS) or a low power wake up signal (LP-WUS).

10. The BS of claim 8, wherein information carried by an overlaid OFDM waveform in the set of overlaid OFDM waveforms is a subset of information carried by the OOK waveform.

11. The BS of claim 8, wherein information carried by a first overlaid OFDM waveform in the set of overlaid OFDM waveforms is different from information carried by a second overlaid OFDM waveform in the set of overlaid OFDM waveforms when the first overlaid OFDM waveform and the second overlaid OFDM waveform correspond to different segments in the OFDM symbol.

12. The BS of claim 8, wherein information carried by the set of overlaid OFDM waveforms is same as information carried by the OOK waveform.

13. The BS of claim 8, wherein an overlaid OFDM waveform in the set of overlaid OFDM waveforms is generated in a frequency domain and mapped to a number of subcarriers in the frequency domain.

14. The BS of claim 8, wherein an overlaid OFDM waveform in the set of overlaid OFDM waveforms is generated according to a low peak-to-average-power ratio (PAPR) sequence.

15. A method of a user equipment (UE) in a wireless communication system, the method comprising:
identifying a set of orthogonal frequency division multiplexing (OFDM) symbols for a low power signal, wherein each OFDM symbol includes one or multiple segments;
determining an on-off-key (OOK) waveform for the low power signal, wherein each segment corresponds to an ON waveform or an OFF waveform;
determining a set of overlaid OFDM waveforms, wherein each overlaid OFDM waveform is applied to a segment when the segment corresponds to an ON waveform; and
receiving the low power signal based on the OOK waveform and the set of overlaid OFDM waveforms.

16. The method of claim 15, wherein the low power signal is one of a low power synchronization signal (LP-SS) or a low power wake up signal (LP-WUS).

17. The method of claim 15, wherein information carried by an overlaid OFDM waveform in the set of overlaid OFDM waveforms is a subset of information carried by the OOK waveform.

18. The method of claim 15, wherein information carried by a first overlaid OFDM waveform in the set of overlaid OFDM waveforms is different from information carried by a second overlaid OFDM waveform in the set of overlaid OFDM waveforms when the first overlaid OFDM waveform and the second overlaid OFDM waveform correspond to different segments in the OFDM symbol.

19. The method of claim 15, wherein information carried by the set of overlaid OFDM waveforms is same as information carried by the OOK waveform.

20. The method of claim 15, wherein an overlaid OFDM waveform in the set of overlaid OFDM waveforms is:
generated according to a low peak-to-average-power ratio (PAPR) sequence;
generated in a frequency domain; and
mapped to a number of subcarriers in the frequency domain.
